(19) United States
(12) Patent Application Publication
(10) Pub. No.: US 2006/0294066 A1
(43) Pub. Date: Dec. 28, 2006

(54) Visual display of information using historical condition support and event profiles

(75) Inventors: Richard D. Dettinger, Rochester, MN (US); Daniel P. Kolz, Rochester, MN (US); Jeffrey W. Tenner, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: International Business Machines Corporation, Armonk, NY (US)

(21) Appl. No.: 11/165,387

(22) Filed: Jun. 23, 2005

(51) Int. Cl. G06F 17/30

(52) U.S. Cl. 707/3

(57) ABSTRACT

A method, system and article of manufacture for providing a visual display of information that quickly conveys how information, as represented by data retrieved for a set of queries, may have changed over time is disclosed. By animating information retrieved for a plurality of queries, a visual display is created that conveys how a data in a database has changed over time. Users compose a query template specifying a plurality of queries. The query template further specifies a time period and frequency range over which the queries in the query template should be executed. After executing a query to retrieve data corresponding to each point in time, a snapshot of the database is available to generate the visual display of information.

### CROSS-REFERENCE TO RELATED APPLICATIONS

This application is related to a commonly assigned, co-pending, U.S. patent application Ser. No. 10/083,075, filed Feb. 26, 2002, entitled “Application Portability and Extensibility through Database Schema and Query Abstraction,” incorporated herein by reference in its entirety. This application is also related to commonly assigned, co-pending U.S. patent application Ser. No. 10/877,230 filed Jun. 25, 2004, entitled “Techniques for Representing Relationships Between Queries,” incorporated herein by reference in its entirety. This application is also related to commonly assigned, co-pending application entitled “Abstract Query Plan,” Ser. No. 11/005,418, filed Dec. 6, 2004, which is incorporated by reference herein in its entirety. This application is also related to commonly assigned, co-pending U.S. patent application entitled “Graphical User Interface to Build Event-Based Dynamic Searches or Queries Using Event Profiles,” Ser. No. 10/094,531, filed Mar. 8, 2002, which is incorporated by reference herein in its entirety.

### BACKGROUND OF THE INVENTION

1. Field of the Invention

The present invention generally relates to query processing and, more particularly, to graphically representing how information stored in a database may have changed over time.

2. Description of the Related Art

Database systems are well known software applications for storing, searching, and retrieving information. The most prevalent type of database used today is the relational database. Relational databases store data using a set of tables that may be organized and accessed in a number of different ways. Users access information in relational databases using a relational database management system (DBMS).

Tables in a relational database are composed from one or more columns. Each column in a database table represents a particular domain of data. Typically, each column has a name and a specific data type. For example, a table storing data about patients treated at a hospital might reference each patient using a patient identification number (represented using an integer data type) stored in a “patient ID” column. Reading across the rows of such a table would provide data about a particular patient. Tables that share at least one attribute in common are said to be “related.” Further, tables without a common attribute may be related through other tables that do share common attributes. A path between two tables is often referred to as a “join,” and columns from tables related through a join may be combined to from a new table returned as a set of query results.

Queries of a relational database may specify which columns to retrieve data from, how to join the columns together, and conditions (predicates) that must be satisfied for a particular data item to be included in a query result table. Relational databases require that queries be composed in complex query languages. One such query language is Structured Query Language (SQL). However, other query languages are also used. An SQL query is composed from one or more clauses set off by a keyword. Well-known SQL keywords include the SELECT, WHERE, FROM, HAVING, ORDER BY, and GROUP BY keywords. Composing a proper SQL query requires that a user understand both the structure and content of the relational database as well as the complex syntax of the SQL query language (or other query language). The complexity of constructing an SQL statement, however, generally makes it difficult for average users to compose queries of a relational database.

Databases are often used to capture information about an organization. Thus, how the database is changing may provide information about how an organization itself is changing. Current technology, however, has no way to answer even uncomplicated questions about how an organization has changed over time. For example, consider a department head wanting to know the answer to a simple question such as: “how have our funding sources changed over the last four years?” It can be very difficult compose relational queries to retrieve and display this information.

Specifically, answering this question requires information about changes that have occurred apart form the ways data values in a particular column may have changed. For example, consider data regarding a group of researchers, each working on projects funded by research grants, a database will likely store information about the projects to which a researcher is assigned, and information about the source and amount of funds available for each project. Over time, the amount of funding from different sources may change, as may the projects individuals are assigned to, even though these changes may not be explicitly captured. For example, even though the database may store data regarding new projects as they are funded, the database does not explicitly store how a new project changes overall funding.

The visual display of how various populations of data are related to one another is also problematic for a relational database. Some versions of SQL provide a “WITH ROLLUP” modifier for the GROUP BY keyword that adds extra rows to query output. The additional rows represent summary operations that aggregate data in one column relative to values in other columns. For example, consider a database of inventory for a multi-location retail business. A query to retrieve current inventory by store that includes a “WITH ROLLUP” modifier will add rows that display total inventory by item type for all stores. SQL queries using the rollup modifier, however, provide aggregate values using a snapshot of data for a specific time. In addition, query results are displayed in tables with NULL values inserted into the extra rows added by the rollup modifier in columns that do not include aggregate data. Users must still compare results in a number of different tables to determine how the database may have changed over time.

Accordingly, there is a need for techniques that allow users to determine how data in a database may have changed over time. Further, there is a need for techniques to display this information to a user in a manner that conveys how data has changed.

### SUMMARY OF THE INVENTION

The present invention generally provides a method, system and article of manufacture for presenting a visual display of information retrieved from the database that quickly conveys a straightforward representation of how data from a database is changing over time.

One embodiment of the invention provides a method of providing a visual display of data in a database. The method generally includes receiving a query template, wherein the query template specifies a plurality of database queries and a temporal data sampling specification specifying a set of points in time for which at least one query should be executed to retrieve data, consistent with the state of the database at each point in time. The method generally further includes executing the at least one query to retrieve data corresponding to the state of the database for each of the points in time, and generating a visual display from the retrieved data, wherein the visual display conveys how the data retrieved for the plurality of individual queries has changed over a time period defined by the points in time. In one embodiment, the plurality of individual queries may include abstract queries composed according to a database abstraction model, wherein the database abstraction model defines a plurality of logical fields, and wherein each logical field specifies an access method for accessing data in the database corresponding to the logical field.

Another embodiment provides a method for displaying how data, stored in a database, may have changed over time. The method generally includes prompting a user to identify (i) a plurality of queries to include in a query template, (ii) which queries, from the plurality of queries, to execute for a plurality of points in time, and (iii) the points in time. The method generally further includes, generating, from the query template, database queries, wherein each database query is configured to retrieve data from the database consistent with one of the points in time, executing the generated queries to retrieve data values that existed in the database for the points in time, and generating, from the retrieved data, a visual display, wherein the visual display conveys how the data has changed, over the time period covered by the points in time.

Another embodiment provides a computer readable medium containing a program, which when executed on a computer system performs an operation for accessing data stored in an underlying physical database. The operations generally include receiving a query template, wherein the query template specifies a plurality of database queries and a temporal data sampling specification specifying a set of points in time for which at least one query should be executed to retrieve data, consistent with the state of the database at each point in time. The operation generally further includes executing the at least one query to retrieve data corresponding to the state of the database for each of the points in time, and generating a visual display from the retrieved data, wherein the visual display conveys how the data retrieved for the plurality of individual queries has changed over a time period defined by the points in time.

Another embodiment provides a system for presenting a visual display of information that shows how data in a database has changed over time. The system generally includes a physical database, wherein the physical database includes a data source that may be queried to determine the state of the database that existed at different points in time, and a database query application. The database query application generally includes a user interface configured to generate a query template by prompting a user to identify (i) a plurality of queries to include in a query template, (ii) which queries, from the plurality of queries, to execute for a plurality of points in time; and (iii) the points in time. The system generally further includes a runtime component configured to generate, from the query template, a plurality of queries configured to retrieve data values that existed in the database corresponding to the points in time, and to execute the generated queries of the database to retrieve data for the points in time, and a user display generator configured to generate, from the retrieved data, a visual display, wherein the visual display conveys how the data has changed over a time period defined by the points in time.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments illustrated by the appended drawings. These drawings, however, illustrate only typical embodiments of the invention and are not limiting of its scope, for the invention may admit to other equally effective embodiments.

FIG. 1 illustrates exemplary computer systems and a data communications environment, according to one embodiment of the invention.

FIG. 2 illustrates a system 200 of software components, according to one embodiment of the invention.

FIG. 3 further illustrates the interaction of software components illustrated in FIG. 2, according to on embodiment of the invention.

FIG. 4 illustrates an exemplary set of relational database tables that may be used by embodiments of the invention.

FIG. 5 illustrates a method for composing and processing a database query used to build a visual display of how data retrieved for the query may have changed over time, according to one embodiment of the invention.

FIGS. 6A-6C illustrate exemplary graphical user interface screens presented to a user composing a database query, according to one embodiment of the invention.

FIG. 7 illustrates a method for generating a plurality of query instances from a template query, according to one embodiment of the invention.

FIGS. 8A-8C illustrate a visual display of query results, according to one embodiment of the invention.

### DETAILED DESCRIPTION OF THE PREFERRED EMBODIMENTS

The present invention provides a method, system and article of manufacture that provides a visual display that quickly conveys how information, as represented by data retrieved for a set of queries, may have changed over time. In one embodiment, a user interacts with a query building interface to build a query template from a set of one or more queries. The template may also specify a frequency period (e.g., a period of minutes, seconds, days, or years) and a time/date range. Queries are then generated from the query template for each point in time, as specified by the period and frequency data. In one embodiment a time query assembler is used to generate and execute an individual query for each time period. Once a query for each period is executed, a user display generator may be configured to generate a visual display of the data retrieved for the queries. For example, the visual display may generate an animation (e.g., a Venn diagram representation or dynamic graph representation) that provides a view of how the information, as represented by the query results, may have changed over time. Alternatively, a set of static representations may be used.

The following description references embodiments of the invention. However, the invention is not limited to any specifically described embodiment. Rather, any combination of the following features and elements, whether related to a described embodiment or not, implements and practices the invention. Furthermore, in various embodiments the invention provides numerous advantages over the prior art. Although embodiments of the invention may achieve advantages over other possible solutions and the prior art, whether a particular advantage is achieved by a given embodiment does not limit the scope of the invention. Thus, the following aspects, features, embodiments and advantages are illustrative of the invention and are not considered elements or limitations of the appended claims; except where explicitly recited in a claim. Similarly, references to “the invention” shall neither be construed as a generalization of any inventive subject matter disclosed herein nor considered an element or limitation of the appended claims; except where explicitly recited in a claim.

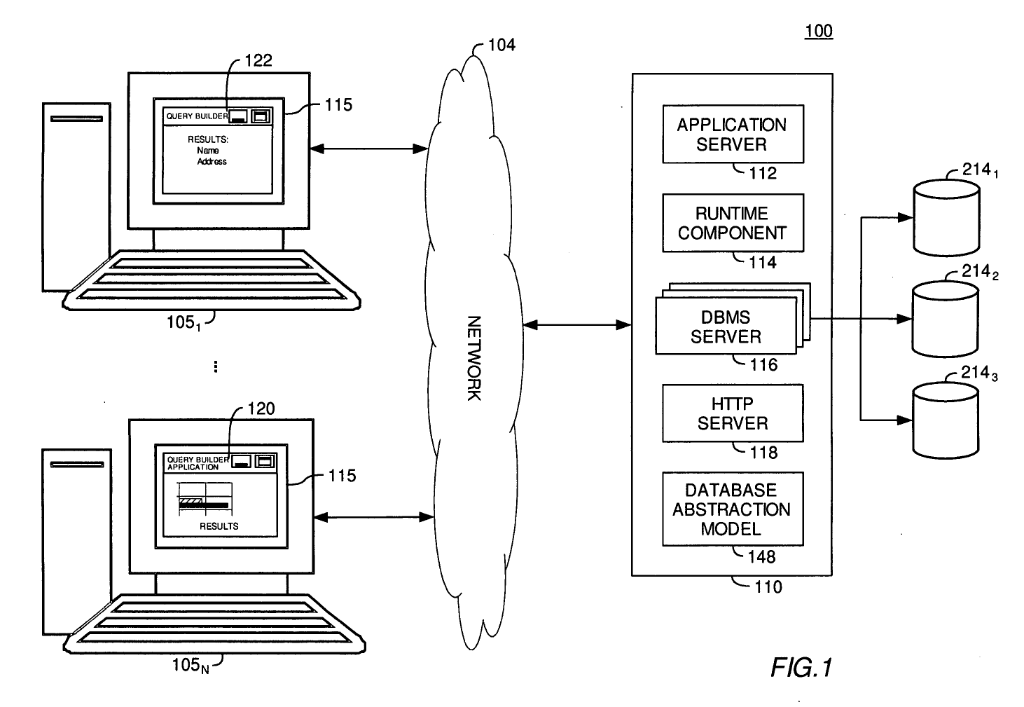

One embodiment of the invention is implemented as a software program, or programs, for use with a computer system such as the computer system 100 illustrated in FIG. 1 and described below. The software program defines functions of the embodiments (including the methods) described herein and can be contained on a variety of computer-readable media. Illustrative computer-readable media include, without limitation, (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed across communications media, (e.g., a computer or telephone network) including wireless communications. This embodiment specifically includes information shared over the Internet or other computer networks. Such computer-readable media, when carrying computer-readable instructions that perform methods of the invention, represent embodiments of the present invention.

In general, software routines implementing embodiments of the invention may be part of an operating system or part of a specific application, component, program, module, object, or sequence of instructions such as an executable script. Such software routines typically comprise a plurality of instructions capable of being performed using a computer system. Also, programs typically include variables and data structures that reside in memory or on storage devices as part of their operation. In addition, various programs described herein may be identified based upon the application for which they are implemented. Those skilled in the art recognize, however, that any particular nomenclature or specific application that follows facilitates a description of the invention and does not limit the invention for use solely with a specific application or nomenclature. Furthermore, the functionality of programs described herein using discrete modules or components interacting with one another. Those skilled in the art recognize, however, that different embodiments may combine or merge such components and modules in many different ways.

Moreover, examples described herein reference an exemplary relational database tables and data related to the funding of projects for a hypothetical medical research center. These examples are provided to illustrate embodiments of the invention, as applied to data from a particular environment. The invention, however, is contemplated for other data environments including, for example, transactional environments, financial environments, research environments, accounting environments, legal environments, and the like.

FIG. 1 illustrates a networked computer system in a client/server configuration. Client computer systems 105_{1-N} include an interface that enables network communications with other systems over network 104. The network 104 may be a local area network where both the client system 105 and server system 110 reside in the same general location, or may be network connections between geographically distributed systems, including network connections over the Internet. Client system 105 generally includes a central processing unit (CPU) connected via a bus, to memory and storage (not shown). Each client system 105 is running an operating system that manages the interaction between hardware components and higher-level software applications running on client system 105. Illustrative operating systems include e.g., a Linux® distribution, Microsoft Windows®, IBM's AIX® or OS/400®, FreeBSD, and the like. (Linux is a registered trademark of Linus Torvalds, in the United States and other countries).

The server system 110 may include hardware components similar to those used by client system 105. Accordingly, the server system 110 generally includes a CPU, a memory, and a storage device, coupled to one another by a bus (not shown). The server system 110 is also running an operating system.

The client/server configuration illustrated in FIG. 1, however, is merely exemplary of one hardware/software configuration. Embodiments of the present invention may be implemented using other configurations, regardless of whether the computer systems are complex multi-user computing systems, such as a cluster of individual computers connected by a high-speed network, single-user workstations, or network appliances lacking non-volatile storage. Additionally, although FIG. 1 illustrates computer systems configured using a client and server type architecture, embodiments of the invention may be implemented in a single computer system, or in other configurations, including peer-to-peer and distributed architectures.

In one embodiment, users interact with the server system 110 using a graphical user interface (GUI) provided by interface 115. In a particular embodiment, GUI content may comprise HTML documents (i.e., web-pages) rendered on a client computer system 105₁ using web-browser 122. In such an embodiment, the server system 110 includes a Hypertext Transfer Protocol (HTTP) server 118 (e.g., a web server such as the open source Apache web-sever program or IBM's Web Sphere® program) configured to respond to HTTP requests from the client system 105 and to transmit HTML documents to client system 105. The web-pages themselves may be static documents stored on server system 110 or generated dynamically using application server 112 interacting with web-server 118 to service HTTP requests. Alternatively, client application 120 may comprise a database front-end, or query application program running on client system 105_{N}. The web-browser 122 and the application 120 may be configured to allow a user to compose an abstract query, and to submit the query to the runtime component 114.

As illustrated in FIG. 1, server system 110 may further include runtime component 114, DBMS server 116, and database abstraction model 148. In one embodiment, these components may be software programs or modules executing on the server system 110. The DBMS server 116 includes a software application configured to manage databases 214₁₋₃. That is, the DBMS server 116 communicates with the underlying physical database system, and manages the physical database environment behind the database abstraction model 148. Users interact with the query interface 115 (running on application 120 or browser 122) to compose an abstract query. In one embodiment an abstract query may be composed from a plurality of logical fields defined by the database abstraction model 148. In one embodiment, the runtime component 114 is configured to generate a query of underlying physical databases 214 from the abstract query. Accordingly, in one embodiment, the runtime component 114 is configured to generate an SQL statement from an abstract query.

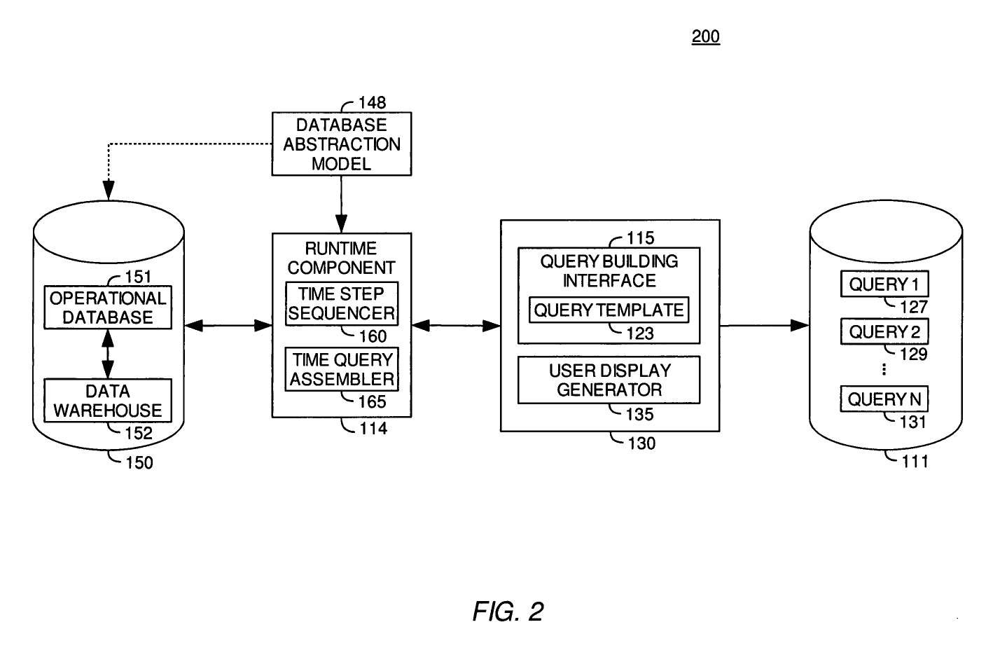

FIG. 2 illustrates a system 200 of software components, according to one embodiment of the invention. The software components illustratively include a query repository 111, a user interface 130, a runtime component 114, a database abstraction model 148, and a database 150 (e.g., one of databases 214₁₋₃).

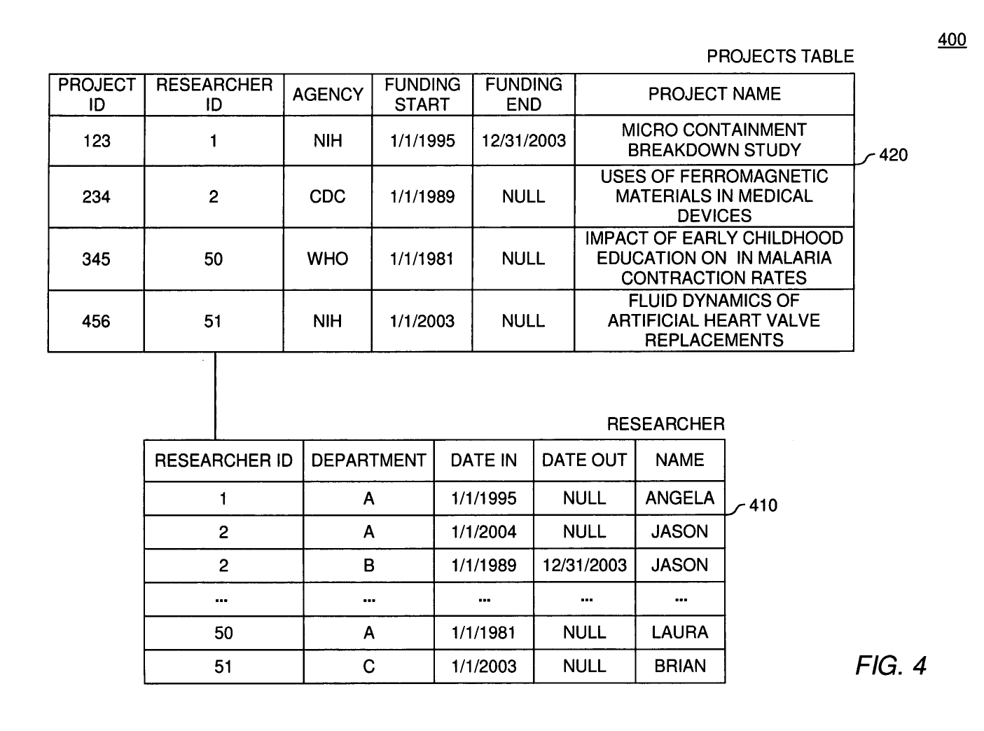

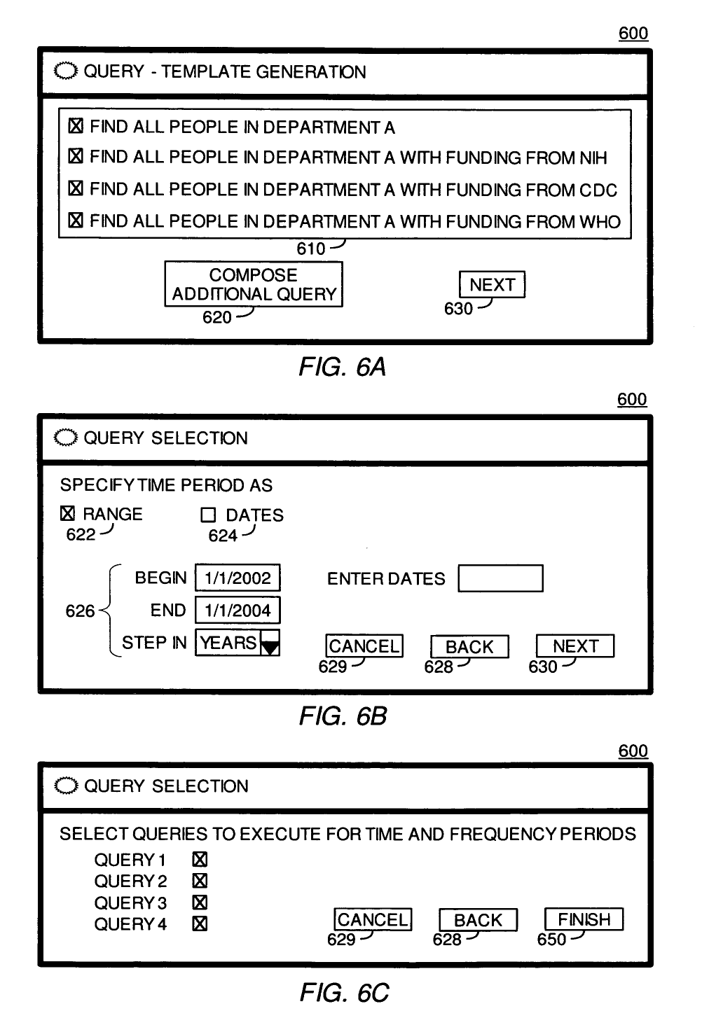

In one embodiment, the user interface 130 includes a query building interface 115 used for composing queries. The interface 115 may be displayed on the monitor of system 105, and users may interact with the interface 115 using well-known devices such as a keyboard and mouse pointer. Other interface devices, however, are contemplated. In one embodiment, users interact with interface 115 to select a plurality of queries included in a query template 133. The queries included in the template are then executed multiple times, each corresponding to a different point in time. The interface 115 and query template 133 are discussed below in reference to FIG. 4 and FIGS. 6A-6C.

The query repository 111 may be used to store queries composed using interface 115. Alternatively, queries may be saved and shared among different users. Illustratively, the query repository 111 includes three previously defined queries 127, 129 and 131. Providing the query repository 111 with the previously defined queries 127, 129 and 131, however, is merely illustrative and not intended to limit the invention. The queries 127, 129 and 131 are defined for execution against data in the database 150.

The database 150 is representative of any collection of data regardless of the particular physical representation. By way of illustration, the database 150 may be organized according to a relational schema (e.g., 214₂), accessible by SQL queries, or according to an XML schema, accessible by XML queries. However, the invention is not limited to a particular physical representation or schema and contemplates extension to schemas presently unknown. Illustratively, database 150 may include an operational database 151 and a data warehouse 152. This is a common database configuration where an organization uses the operational database 150 for the day-to-day operations. Accordingly, the operational database 150 is optimized to process data entry type transactions such as queries composed from the SQL INSERT keyword. Periodically (e.g., at regular intervals), data from the operational data store 150 is copied to the data warehouse 152. The data warehouse 151 transforms data from the operational data store 151 into a form optimized for searching and selecting data.

In a particular embodiment, the queries 127, 129 and 131 are abstract queries. An abstract query is composed using logical fields defined by a database abstraction model 148. Each logical field is mapped to data in the database 150, as illustrated by the dashed line connecting the database abstraction model 148 and database 150. The database abstraction model 148 defines the logical fields independently from the underlying data representation 150, thereby allowing users to compose queries that are loosely coupled to the representation used by the underlying database 150. In one embodiment, the database abstraction model 148 provides definitions for a set of logical fields. Users compose an abstract query by specifying logical fields to include in selection criteria and results criteria. The resulting query is generally referred to herein as an “abstract query” because it is composed using logical fields rather than direct references to data structures in the underlying physical databases 214. Further, because the logical fields are tied to neither the syntax nor semantics of the database 150, additional capabilities may be provided by the database abstraction model without having to modify the underlying database 150.

The runtime component 114 may be configured to access data from database 150, or to modify (i.e., insert, delete or update) data from database 150. To execute an abstract query (e.g., queries 127, 129, and 131) against the database 150, the runtime component 114 transforms the abstract query into a form consistent with the underlying representation of the data in database 150 (referred to herein as a resolved query). That is, the runtime component receives an abstract query, and using the access methods of the logical fields included in the abstract query, generates a resolved query of database 150. Transformation of abstract queries into resolved queries is described in detail in the commonly owned, co-pending U.S. patent application Ser. No. 10/083,075, entitled “Application Portability And Extensibility Through Database Schema And Query Abstraction,” filed Feb. 26, 2002, which is incorporated by reference in its entirety.

In one embodiment, the database 150 includes a time variable data source. A time variable data source may be queried to retrieve current values, but also may be queried to retrieve values corresponding to the state of the database at a prior point in time. In one embodiment, database 150 may maintain prior values for data elements in a column using a database trigger. Such a trigger may be configured to copy values being updated into a table used to store historical values for the column containing the values being updated. For example, by using the SQL INSERT keyword. Thus, a time variable data source may maintain the current value for data elements, and may also be queried for a former value by retrieving data from the table used to store historical values. Also, embodiments of the database abstraction model 148 may provide historical condition support. Historical condition support allows an abstract query to include a conditional modifier signaling that a logical field included in the abstract query should map to a prior value (e.g., a date specified by the conditional modifier). If the access method 208 maps to a table and column of current values, the conditional modifier may be used to indicate that the logical field should be dynamically mapped to the table used to store historical values for the column of the current values. Processing abstract queries that include conditional modifiers are further described in commonly assigned, U.S. Patent application “Utilization of Logical Fields with Conditional Modifiers in Abstract Queries,” Ser. No. 11/005,418, filed Dec. 6, 2004, which is incorporated by reference herein in its entirety.

Additionally, if the database does not maintain a table used to store historical values for the column, the runtime component 114 may be configured to add an event profile to an abstract query. An event profile modifies a condition specified in an abstract query to include a restriction based on other search criteria. In other words, an event profile specifies a contemporaneous condition evaluated along with a primary condition. For example, an event profile for the query “find all researches associated with projects funded by organization X” could include an event profile limiting the condition “funded by organization X” to data for a particular date (i.e., where the contemporaneous condition “date=Y” is also true). Event profiles are described in greater detail in commonly assigned, U.S. patent application Ser. No. 10/094,531, entitled “Graphical User Interface to Build Event-Based Dynamic Searches or Queries Using Event Profiles,” filed on Mar. 8, 2002, which is incorporated by reference herein in its entirety.

By using conditional modifiers, or adding an event profile to query conditions, a query may be executed against a simulated version of the database as it existed at a prior time. Further, by using tables to store prior data values, prior versions of the database may be stored as part of the database itself. If a database does not maintain this data directly, adding an event profile to a query mimics the same functionality by placing a first condition evaluated against a second condition included in the abstract query.

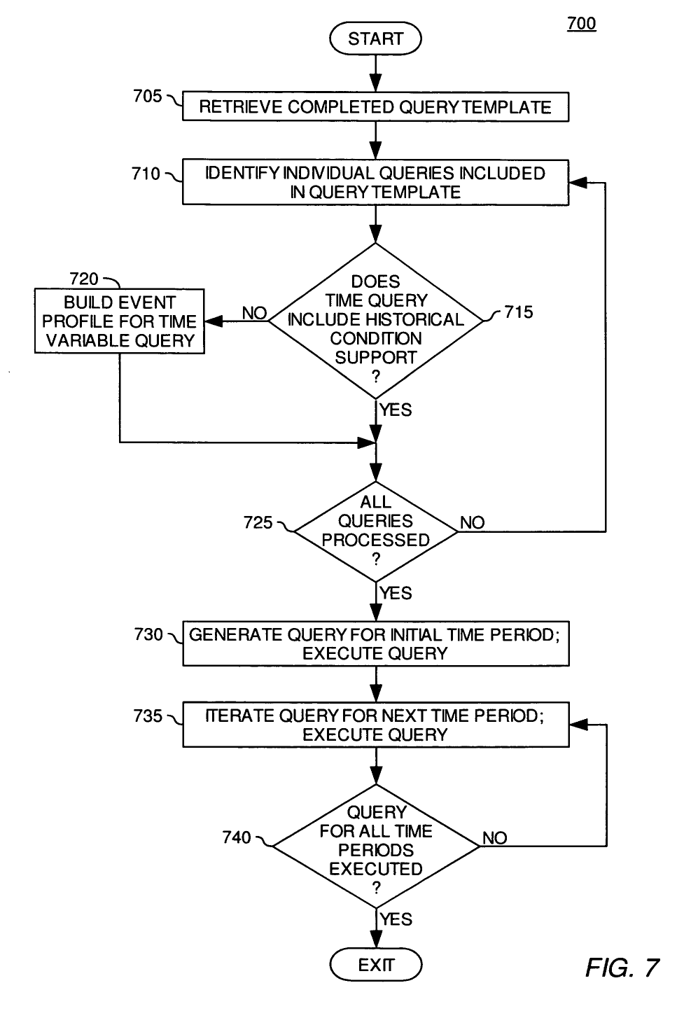

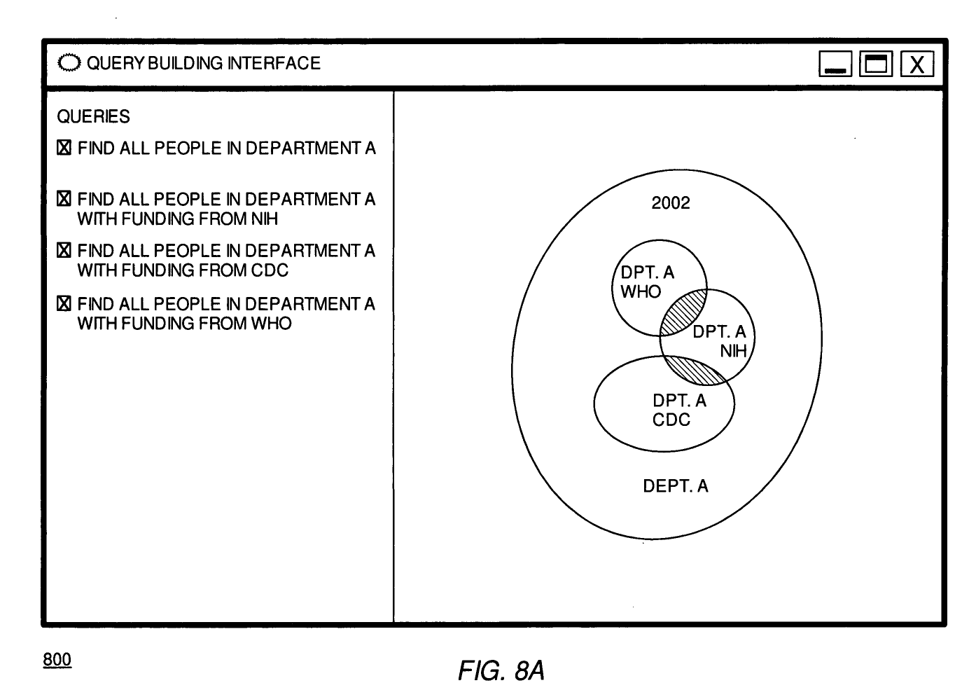

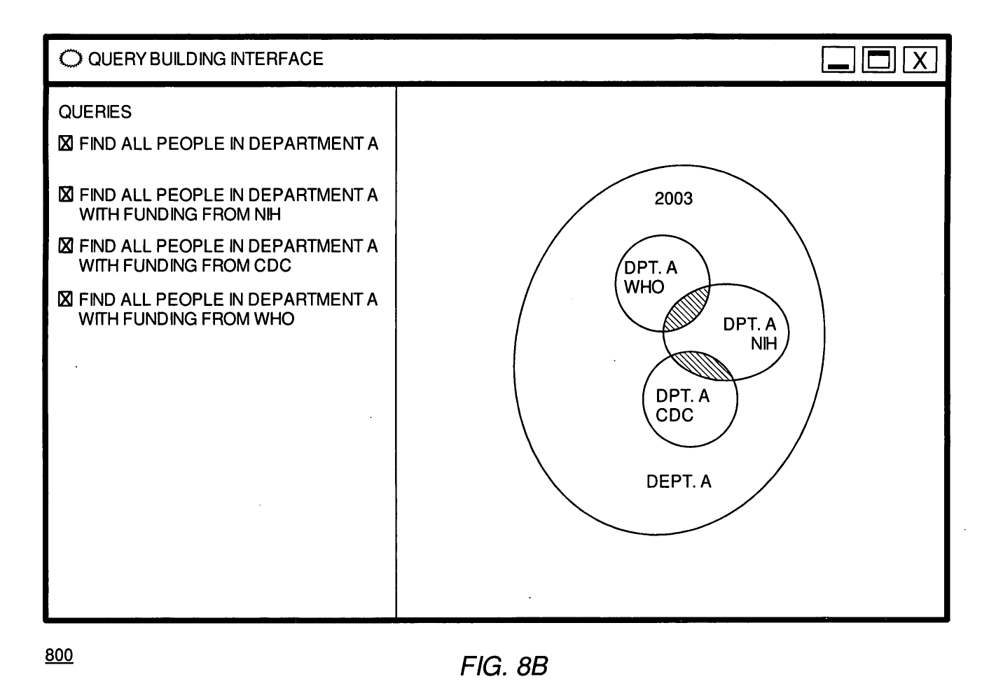

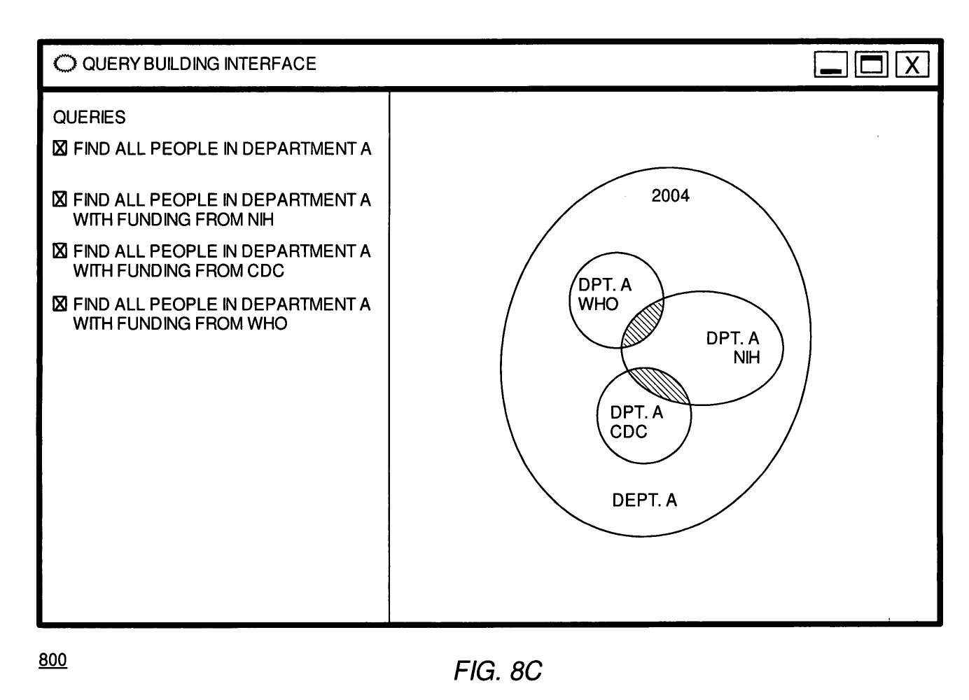

In one embodiment, the runtime component 114 may further include a time step sequencer 160, and time query assembler 165. In one embodiment, the time step sequencer 160 is a software component configured to process user input (e.g., received from user interface 130) and to orchestrate the activity of other components in the system 200 (e.g., DBMS 116, database 150 and display generator 135). The time query assembler 165 may also be a software component, configured to generate a plurality of queries from a query template 133. In one embodiment, each query generated from the query template 133 is used to access data for a specific point in time. The time step sequencer 160 may be configured to store the results as queries are executed for different points in time. After a query is executed for each time period specified by the query template 133, the time step sequencer 160 may provide the query results to a user display generator 135. In turn, the user display generator 135 may be configured to generate a visual display from the data retrieved for the set of queries generated from the query template 133. In one embodiment, the display animates the data retrieved for each individual time period, providing a user with a visual display that illustrates how the data represented by the query results may have changed over time. The operations of the user display generator 135 are discussed in reference to FIG. 7 and FIGS. 8A-8C.

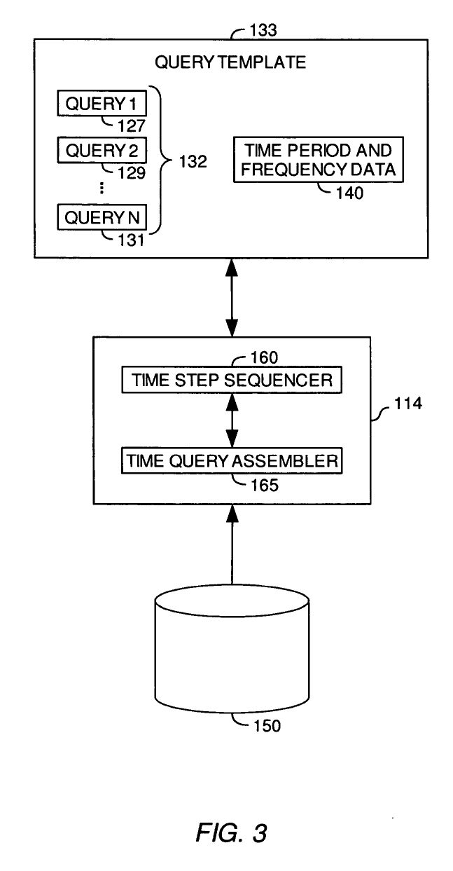

FIG. 3 illustrates a relational view of some of the software components illustrated in FIG. 2. In one embodiment, the query template 133 may include a data structure that stores a plurality of individual queries 132 along with time and frequency period data 140. Illustratively, the query template 133 includes queries 127, 129, and 131. The time period and frequency data 140 are used to determine the points in time for which individual queries, generated from the template queries 132, should be executed. The time step sequencer 160 may receive the query template 133, and in cooperation with time query assembler 165, generate the individual queries. Each query in the template is used to generate a time-based query for each time period, as specified by time period and frequency data 140. Once generated, the queries for each time period are used to retrieve a snapshot of data corresponding to the state of the database 150 at a specific point in time. The actual points in time specified may include both discrete moments (i.e., a singular point in time) or may include a span of time (e.g., the month of June for the previous five years).

FIGS. 4-8 provide an illustrative example of the operations of the various software components described above, according to one embodiment of the invention. FIG. 4 illustrates two exemplary relational database tables. Illustratively, database table 410 stores data about researchers and database table 420 stores data about projects. In this example, each researcher is associated with a project with one of three sponsors: the NIH, the CDC, or the WHO. Also, each project is managed by one researcher, indicated by the “researcher ID” column. Data between table 410 and table 420 may be joined through values from the “researcher ID” column. The example database 400 is used to illustrate the actions of a department head in composing a query to determine how many researchers are funded by each agency, and how that information has changed over the previous three years. Those skilled in the art will recognize that the example database 400 illustrated in FIG. 4 is simplified to illustrate embodiments of the present invention, and that a “production” database environment would likely include many more tables with additional columns, and more complex relationships between the tables.

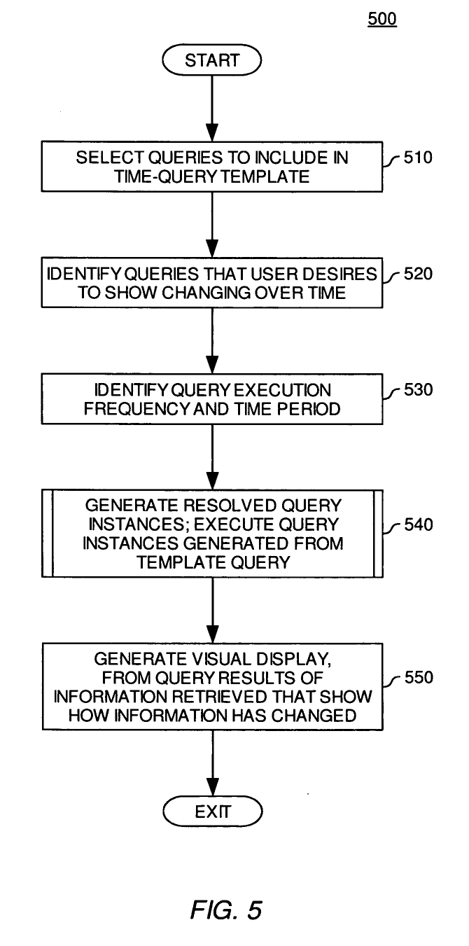

FIG. 5 illustrates a method for composing and processing a database query used to build a visual display of how data retrieved for the database query may have changed over time, according to one embodiment of the invention. The method 500 begins at step 510 where a set of queries 132 to be included in the query template 133 are selected. In one embodiment, a user interacting with query interface 115 selects from a display of queries stored in query repository 111. Alternatively, the query building interface 115 may allow a user to write new queries to include in the query template 133. Such queries may be relational queries written in SQL directly (e.g., by an advanced user) or may also be abstract queries composed from the logical fields defined by the database abstraction model 148.

For example, FIG. 6A illustrates an exemplary graphical user interface screen 600 presented to a user interacting with query interface 115, according to one embodiment of the invention. Illustratively, the query selection 610 includes four abstract queries selected by a user to include in query template 133.

1. Find all people in department A

2. Find all people in department A with funding from NIH

3. Find all people in department A with funding from CDC

4. Find all people in department A with funding from WHO

Button 620 allows a user to add additional queries, for example, by composing a new query or selecting a pre-existing query from query repository 111. Once a user has selected all of the desired queries, pressing “Next” button 630 allows a user to continue composing query template 133.

Returning to the method 500 of FIG. 5, at steps 520 and 530, the user provides additional information to complete query template 133. At step 520, the queries that should be executed for multiple points in time are identified. For example, the user interface 115 may prompt a user to identify which query, or queries, selected in step 510 should be executed to retrieve data corresponding to different points in time. At step 530, the query execution frequency and period is specified.

For example, FIG. 6B illustrates screen 600 after a user has selected a set of queries (e.g., as part of step 510 of method 500). As illustrated, the screen 600 allows a user to select a range of time using checkbox 622, or to specify individual dates as the different points of time using checkbox 624. When a user selects a range of time, GUI form inputs 626 may be used to specify the frequency and period desired by a user. In this example, the range checkbox 622 is selected, and a user has selected to execute the queries illustrated in FIG. 6A for a yearly period of for the years 2002 through 2004. After specifying this information, a user may continue the process by selecting “Next” button 630. Additionally, a user may return to the query selection screen of FIG. 6A using “Back” button 628 or cancel the query template generation process using “Cancel” button 629.

FIG. 6C illustrates a screen 600 presented to a user to select which queries should be executed for the time and frequency periods selected at step 530. As illustrated, screen 600 shows each of the four queries selected at step 510. In other words, each of the four queries will be executed to retrieved data for each point of time as specified in step 530 of method 500. For other groups of queries, fewer then all queries are selected at step 530. This allows a user to compose a query to show how data retrieved for some queries may have changed, relative to data retrieved for a query not executed multiple times. After specifying the desired queries to be iterated over the time and frequency periods, a user may continue the method 500 by selecting “Finish” button 650. Alternatively, a user may return to the query selection screen of FIG. 6B using “Back” button 628 or cancel the query template generation process using “Cancel” button 629.

Returning to the method 500 illustrated in FIG. 5, after specifying the queries and information needed to complete query template 133, the completed query template 133 may be provided to runtime component 114 for processing. In one embodiment, the runtime component 114 receives the query template 133 over network 104 using well-known data communication protocols. Once the query template 133 is received, the runtime component 114 may be configured to generate a set of query instances (step 550). Each query instance corresponds to the queries specified in step 510, modified to reflect the frequency and time periods of query execution specified in steps 520 and 530. One embodiment of a method to generate the query instances is illustrated in reference to FIG. 7. At step 540, the query instance for each time period is executed, retrieving data for each point in time specified by frequency and period data.

At step 550, a visual display of the information retrieved at step 540 is generated. For example, in one embodiment, the visual display may show an animation (e.g., a Venn diagram representation or dynamic graph representation) that provides a nearly continuous view of how the information, as represented by the query results, may have changed over time. In one embodiment, a visual display generator 135 may be configured to receive data retrieved for an individual query from template 133, (e.g., query 129) and generate a display illustrating how the data may have increased or decreased between each point in time (i.e., at each frequency period). For example data retrieved for query No. 2, above, shows that funding by the NIH may have grown between 2002 and 2004 (as project 456 was added on Jan. 1, 2003). But may have declined beginning in 2004 (as project 123 ended on Dec. 31, 2003). A visual display representing this change in funding might include a pie chart, wherein the wedge representing the NIH first expands and than contracts, relative to other wedges. FIGS. 8A-8C illustrate a representation using a Venn diagram where funding is represented using the area of overlapping circles, that change in size to reflect changes in funding that have occurred over time. Additional examples of generating a visual display of data are disclosed in commonly assigned, co-pending U.S. patent application Ser. No. 10/877,230 filed Jun. 25, 2004, entitled “Techniques for Representing Relationships Between Queries,” incorporated herein by reference in its entirety.

FIG. 7 illustrates a method 700 for generating a plurality of query instances from template query 133, according to one embodiment of the invention. The method 700 begins at step 705 where the runtime component 114 receives a completed query template 133. At step 710, the method iterates through a loop comprising steps 715 through 725. The loop allows the time query assembler 165 processes each query included in the query template (e.g., as part of step 510 of method 500) that should be executed for multiple points in time. In an embodiment where users compose an abstract query from a plurality of logical fields defined by a database abstraction model 148, the method 700 queries whether time variable queries include logical fields for which historical condition support is available (step 715). If not, the time query assembler 165 may be configured to modify the abstract query under consideration to include an event profile that adds the date and time conditions to the abstract query under consideration (step 720). At step 725, the method determines whether all queries identified at step 710 have been processed. If so, the method proceeds step 730. Otherwise, the process returns to step 710 and selects another query included in the query template 133 for processing through steps 715 through 725.

After exiting the loop, at step 730, the time query assembler 165 generates a plurality of query instances, one for each time period specified by frequency and period data. Each query instance is itself composed from the plurality of individual queries specified by the query template 133, wherein each query (e.g., queries 127, 129, and 131) is modified to retrieve data corresponding to a specific point in time. The individual queries are executed at step 735 to retrieve a set of query results, one set of query results corresponding to each point in time specified by period and frequency data 140. After retrieving query data for each point in time as specified by period and frequency data 140, the method then concludes at step 740.

In one embodiment, data retrieved according to the method 700 may be provided to the visual display generator 135 of user interface 130. Illustratively, FIGS. 8A-8C show a representation of the data retrieved for each of the four queries specified as part of step 510 of method 500. Specifically, each figure displays a visual representation of the four queries specified by the exemplary query template 133. The visual display illustrated in FIGS. 8A-8C shows data retrieved for these four queries for the years 2002, 2003, and 2004. Illustratively, FIGS. 8A-8C depict that the funding from NIH has grown and that fewer researchers are being funded by both CDC and NIH, over time. In one embodiment, when presented on a monitor display of user interface 115, the display may animate the data, allowing the relative areas of the circles to change according to the funding changes that have occurred for the hypothetical research organization described above. Further, the visual display generator may generate a display that allows users to click on any interesting area and get statistics about how that area is changing over time. Alternatively, the interface may be configured to highlight the area or areas that are growing or shrinking fastest or above a certain rate. Other extensions and modifications to the techniques disclosed herein may be apparent to those of skill in the art.

### CONCLUSION

Embodiments of the invention may be used to highlight in an efficient visual display how information stored by a database is changing, over time. A query building interface is used to build a query template from a set of one or more queries. The template may also specify a frequency period (e.g., a period of minutes, seconds, days, or years) and a time/date range. Queries are then generated from the query template for each point in time, as specified by the period and frequency data. In one embodiment, a time query assembler is used to generate and execute the individual queries for each time period. Once the queries are executed, a user display generator may be configured to generate a visual display of the data. Embodiments of the invention may be applied whenever historical information about a query is available. By using historical condition support and event profiles, users are presented with a visual display of information that conveys how data, and therefore an organization, may have changed over time. In one embodiment, the visual display provides a concise, easy to understand representation of how the data may have changed over time.

While the foregoing is directed to embodiments of the present invention, other and further embodiments of the invention may be devised without departing from the basic scope thereof, and the scope thereof is determined by the claims that follow.

What is claimed is:

1. A method of providing a visual display of data in a database, comprising:
receiving a query template, wherein the query template specifies:
a plurality of database queries; and
a temporal data sampling specification specifying a set of points in time for which at least one query should be executed to retrieve data, consistent with the state of the database at each point in time;
executing the at least one query to retrieve data corresponding to the state of the database for each of the points in time; and
generating a visual display from the retrieved data, wherein the visual display conveys how the data retrieved for the plurality of individual queries has changed over a time period defined by the points in time.

2. The method of claim 1, wherein the temporal data sampling specification specifies time period and frequency data.

3. The method of claim 1, wherein the plurality of database queries are selected from a repository of existing queries.

4. The method of claim 1, wherein each of the plurality of individual queries comprises an abstract query composed according to a database abstraction model, wherein the database abstraction model defines a plurality of logical fields, and wherein each logical field specifies an access method for accessing data in the database corresponding to the logical field.

5. The method of claim 4, wherein executing the plurality of individual queries comprises:
transforming each abstract query into a query consistent with the particular physical data representation used by the database; and
issuing the transformed queries against the database.

6. The method of claim 4, wherein at least one logical field included in the at least one query specifies a conditional modifier indicating that the at least one logical field should access a value for the logical field corresponding to the value for the logical field that existed in the database, at a point in time specified by the conditional modifier.

7. The method of claim 1, wherein the visual display comprises an animated display that conveys how data retrieved for the plurality of queries has changed, relative to one another, over the time period covered by the specific points in time.

8. A method for processing a database query, comprising:
prompting a user to identify (i) a plurality of queries to include in a query template, (ii) which queries, from the plurality of queries, to execute for a plurality of specific points in time; and (iii) the specific points in time;
generating, from the query template, database queries, wherein each database query is configured to retrieve data from the database consistent with one of the specific points in time;
executing the generated queries to retrieve data values that existed in the database for the specific points in time; and
generating, from the retrieved data, a visual display, wherein the visual display conveys how the data has changed, over the time period covered by the specific points in time.

9. The method of claim 8, wherein the plurality of queries are selected from a repository of existing queries.

10. The method of claim 8, wherein each of the plurality of queries comprises an abstract query composed according to a database abstraction model, wherein the database abstraction model defines a plurality of logical fields, and wherein each logical field specifies an access method for accessing data in the database corresponding to the logical field.

11. The method of claim 10, wherein executing the generated queries comprises:
transforming each abstract query into a query consistent with a particular physical data representation used by the database; and
issuing the transformed queries against the database.

12. The method of claim 10, wherein at least one logical field included in one of the plurality of query specifies a conditional modifier indicating that the at least one logical field should access a value for the logical field corresponding to a prior value for the logical field that existed in the database, at a point in time specified by the conditional modifier.

13. The method of claim 8, wherein the visual display comprises an animated display that conveys how data retrieved for the plurality of queries has changed, relative to one another, over the time period covered by the specific points in time.

14. A computer-readable medium containing a program, which when executed on a computer system performs an operation for accessing data stored in an underlying physical database, comprising:
receiving a query template, wherein the query template specifies:
a plurality of database queries; and
a temporal data sampling specification specifying a set of points in time for which at least one query should be executed to retrieve data, consistent with the state of the database at each point in time;
executing the at least one query to retrieve data corresponding to the state of the database for each of the points in time; and
generating a visual display from the retrieved data, wherein the visual display conveys how the data retrieved for the plurality of individual queries has changed over a time period defined by the points in time.

15. The computer-readable medium of claim 14, wherein the plurality of database queries are selected from a repository of existing queries.

16. The computer-readable medium of claim 14, wherein each of the plurality of database queries comprises an abstract query composed according to a database abstraction model, wherein the database abstraction model defines a plurality of logical fields, and wherein each logical field specifies an access method for accessing data in the database corresponding to the logical field.

17. The computer-readable medium of claim 16, wherein executing the generated queries comprises:
transforming each abstract query into a query consistent with a particular physical data representation used by the database; and
issuing the transformed queries against the database.

18. The computer-readable medium of claim 16, wherein at least one logical field included in one of the plurality of query specifies a conditional modifier indicating that the at least one logical field should access a value for the logical field corresponding to a prior value for the logical field that existed in the database, at a point in time specified by the conditional modifier.

19. The computer-readable medium of claim 14, wherein the visual display comprises an animated display that conveys how data retrieved for the plurality of queries has changed, relative to one another, over the time period covered by the specific points in time.

20. A system for presenting a visual display of information that shows how data in a database has changed over time, comprising:
a physical database, wherein the physical database includes a data source that may be queried to determine the state of the database that existed at different points in time;
a database query application comprising:
a user interface configured to generate a query template by prompting a user to identify (i) a plurality of queries to include in a query template, (ii) which queries, from the plurality of queries, to execute for a plurality of specific points in time; and (iii) the specific points in time;
a runtime component configured to generate, from the query template, a plurality of queries configured to retrieve data values that existed in the database corresponding to the points in time, and to execute the generated queries of the database to retrieve data for the points in time; and
a user display generator configured to generate, from the retrieved data, a visual display, wherein the visual display conveys how the data has changed over a time period defined by the points in time.

21. The system of claim 20, wherein the plurality of queries each comprise an abstract query composed according to a database abstraction model, wherein the database abstraction model defines a plurality of logical fields, and wherein each logical field specifies an access method for accessing data in the database corresponding to the logical field.

22. The system of claim 20, wherein executing the plurality of queries comprises transforming each abstract query into a query consistent with the particular physical data representation used by the database, and issuing the transformed queries against the database.
